(19) United States
(12) Patent Application Publication
(10) Pub. No.: US 2006/0059428 A1
(43) Pub. Date: Mar. 16, 2006

(54) Method and system for presenting relationships

(76) Inventors: Marshall L. Humphries, Austin, TX (US); Khan M. Tasinga, San Jose, CA (US); Brian D. Armstrong, Houston, TX (US)

Correspondence Address: TIMOTHY N. ELLIS, PATENT ATTORNEY, 8680 VIA MALLORCA, SUITE D, LA JOLLA, CA, 92037, US

(21) Appl. No.: 10/933,018

(22) Filed: Sep. 1, 2004

(51) Int. Cl. G06F 17/00

(52) U.S. Cl. 715/734; 715/853

(57) ABSTRACT

One aspect of the invention is a method for presenting relationships. An example of the method includes specifying a set of objects. This example also includes designating a root node of the set of objects. This example also includes selecting a first level object type for a first level. This example further includes, for at least one object having the first level object type, providing and associating therewith a corresponding first level container tree node connected to the root node. Additionally, this example includes adding a child container tree node at a level below the first level, wherein the child container tree node is added only if an object associated with the child container tree node is not in a path between the child container tree node and the root node.

### BACKGROUND

1. Technical Field

The present invention relates to presenting relationships. More particularly, the invention concerns presenting complex relationships as a hierarchical tree.

2. Description of Related Art

Complex relationships, such as the topology of a storage area network (SAN) in a computing system, the relationships between people in a matrix management structure, the end policies that are created as the result of multiple distributed policies, or the love connections of the average soap opera character, are difficult to represent. Representing complex relationships is especially difficult when there are a large number of objects to track. It is very difficult to see both a “big picture” view of all the relationships, and to track the relationships of any one element in the picture, because in these sorts of complex relationships, one element may be connected in more than one location in the big picture. A common approach to representing complex relationships utilizes a hyperbolic tree which attempts to represent all of the relationships between objects as lines, creating a spider-web-like appearance. While this type of hyperbolic tree works well for a small number of objects, it quickly becomes unwieldy when the number of objects exceeds approximately ten. Another method for displaying complex relationships is the drill-down approach. With the drill-down approach, only one layer (level of a tree) is displayed at a time, and a user must drill-down into each successive layer, with each successive layer replacing the view of the previous layer. Although the drill-down approach helps to hide the complexity of the relationships between objects, and facilitates tracking the relationships of individual objects, with the drill-down approach it is nearly impossible to see the “big picture” view of how the objects are interconnected.

Many-to-many relationships can create infinite loops when displayed. For example, in a SAN having an Agent 1, which is connected to a Switch 1, which is connected to a Switch 3, which is connected to the Agent 1, the display may loop as follows: Agent 1 is connected to Switch 1, which is connected to Switch 3, which is connected to Agent 1, which is connected to Switch 1, which is connected to Switch 3, etc. Known techniques have avoided this problem by populating only one level (layer) of a tree at a time, using the drill-down approach mentioned above. This avoids an infinite recursion loop because the tree does not have to “complete” before being displayed. Instead, the tree only populates the next level down when the user expands a node. However, as mentioned above, when only one level is populated at a time, it is nearly impossible to see the “big picture” view of how the objects are interconnected.

Known techniques do not have the ability to clearly present many-to-many relationships as a tree. For example, with MS Active Directory (produced by Microsoft Corporation), in the Computers and Users View, Computers, Users, and User Groups are leaf nodes and peers of each other. Although Active Directory allows users to be assigned to more than one policy group displayed in a tree, Active Directory does not have any facility for directly displaying those relationships in the tree. With Active Directory, in order to assign a user to more than one policy group, a new user group must be created, and the user must be assigned to the new user group. Because User Groups and Users are both peers and leaf nodes (they do not serve as containers in the tree), the assignment of a user to more than one policy group is not created or displayed within the tree. Instead, information regarding these relationships is obtained through right-click properties menus. Pop-up dialogs show the contents of User Groups, and it is only in these pop-ups, in a separate window from the tree, that information regarding assignment of a user to multiple user groups is displayed.

In summary, known methods for representing complex relationships between objects are often inadequate.

### SUMMARY

One aspect of the invention is a method for presenting relationships. An example of the method includes specifying a set of objects. This example also includes designating a root node of the set of objects. This example also includes selecting a first level object type for a first level. This example further includes, for at least one object having the first level object type, providing and associating therewith a corresponding first level container tree node connected to the root node. Additionally, this example includes adding a child container tree node at a level below the first level, wherein the child container tree node is added only if an object associated with the child container tree node is not in a path between the child container tree node and the root node.

Other aspects of the invention are described in the sections below, and include, for example, a computing system, and a signal bearing medium tangibly embodying a program of machine-readable instructions executable by a digital processing apparatus to perform a method for presenting relationships.

The invention provides a number of advantages. For example, some examples of the invention advantageously present a clear big picture view of many-to-many relationships, while permitting tracing the relationships of any individual object. Also, some examples of the invention present a tree for presenting many-to-many relationships, without presenting infinite loops. Further, some examples of the invention beneficially permit an object to be associated with more than one node in a tree. The invention also provides a number of other advantages and benefits, which should be apparent from the following description.

### BRIEF DESCRIPTION OF THE DRAWINGS

FIG. 1 is a block diagram of the hardware components and interconnections of a computing system in accordance with an example of the invention.

FIG. 2 is a block diagram of the hardware components and interconnections of a computing system in accordance with an example of the invention.

FIG. 3 is a block diagram of the hardware components and interconnections of a computing apparatus in accordance with an example of the invention.

FIG. 4 is an example of a signal-bearing medium in accordance with an example of the invention.

FIGS. 5A, 5B, 5C and 5D are a flowchart of an operational sequence for presenting relationships in accordance with an example of the invention.

FIG. 6 is a partial view of the relationships of the objects of a Storage Area Network (SAN), represented as a tree in accordance with an example of the invention.

FIG. 7 is a representation of a window showing a tree utilizing an infinite-recursion preventing algorithm in accordance with an example of the invention.

FIG. 8 is a representation of a window showing a tree wherein the number of levels is limited to three in accordance with an example of the invention.

FIG. 9 is a representation of a window showing a tree after application of an inclusive filter in accordance with an example of the invention.

FIG. 10 is a representation of a window showing a tree after application of an exclusive filter in accordance with an example of the invention.

FIG. 11 is a representation of a SAN divided into two zones.

FIG. 12 is a representation of a window showing a tree representing objects assigned to a zone, in accordance with an example of the invention.

FIG. 13 is a representation of a window showing properties associated with an object, in accordance with an example of the invention.

FIG. 14 is a representation of a tree for a SAN, from a host-centric view, in accordance with an example of the invention.

### DETAILED DESCRIPTION

The nature, objectives, and advantages of the invention will become more apparent to those skilled in the art after considering the following detailed description in connection with the accompanying drawings.

### I. Hardware Components and Interconnections

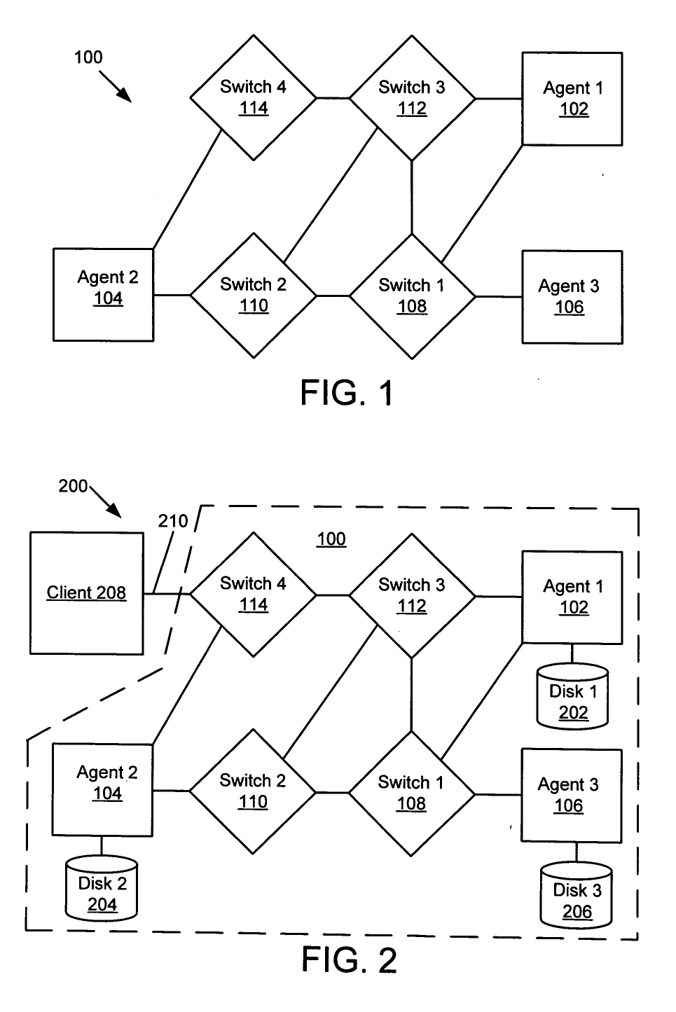

One aspect of the invention is a computing system for presenting relationships. As an example, the computing system may be used to present the relationships between agent1 102, agent2 104, agent3 106, switch1 108, switch2 110, switch3 112, and switch4 114 of the Storage Area Network (SAN) 100 shown in FIG. 1. This may be called presenting the topology of the SAN 100. However, a computing system (or a signal bearing medium, or a method) for presenting relationships in accordance with examples of the invention may be used to present any types of relationships, for example, the relationships between objects in a computing network (for example a LAN (Local Area Network), WAN (Wide Area Network), or the Internet), the relationships between people in a matrix management structure, the relationships between the end policies that are created as the result of multiple distributed policies, or the love connections of the average soap opera character.

Although the invention is relevant to several fields, including those described above, herein the example of displaying the topology of a storage area network (SAN) will generally be discussed. A SAN is an excellent example for this problem area because a SAN can consist of hundreds of objects that are interconnected to each other such that any given object may have multiple connections to any other given object. The specific example of the SAN 100 shown in FIG. 1 includes four switches and three host computers (also called agents), namely agent1 102, agent2 104, agent3 106, switch1 108, switch2 110, switch3 112, and switch4 114. The relationship among these objects is complex because switch1 108, switch2 110, and switch3 112 are all connected to each other, and because agent1 102 is connected to both switch1 108 and switch3 112.

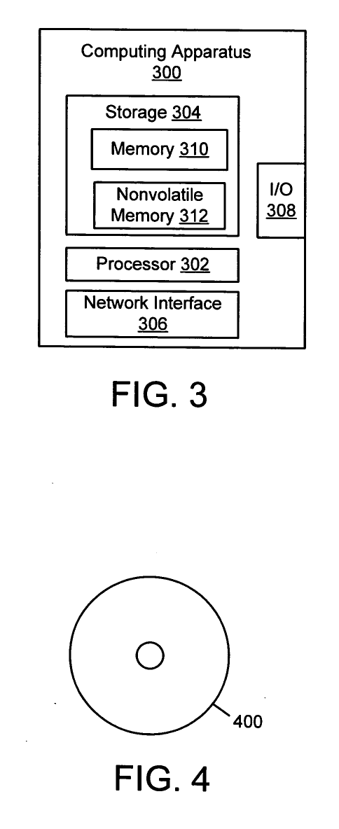

A computing system for presenting relationships in accordance with some examples of the invention may be embodied by all, or portions of, the SAN 100 shown in FIG. 1. Alternatively, a computing system for presenting relationships in accordance with some examples of the invention may be embodied by all, or portions of, the computing system 200 shown in FIG. 2. Alternatively, a computing system for presenting relationships may be embodied by a computing device, such as the computing apparatus 300 shown in FIG. 3. As an example, the computing apparatus 300 may be used to implement the client 208, which is shown coupled to the SAN 100 in FIG. 2, and/or could be used to implement any of the agents 102, 104, 106 in the SAN 100. Alternatively, a computing device for presenting relationships in accordance with examples of the invention (for example the computing apparatus 300), need not be coupled to a SAN or any other computing network. In other examples, a computing system for presenting relationship in accordance with some examples of the invention may be implemented with any suitable computing device, for example, a microprocessor, a personal computer, a hand held computer, a personal digital assistant, a computing device in a mobile telephone, a workstation, or a supercomputer. Some examples of the invention could be implemented to run on web browsers, and thus, a computing system for presenting relationships in accordance with some examples of the invention could be implemented with any computing device that is capable of running a web browser. In other examples, aspects of the invention may be embodied in software adapted to run on any of a wide selection of computing devices, running any of a wide selection of operating systems, and consequently, a computing system for presenting relationships in accordance with some examples of the invention may be implemented on many different types of computing devices. Techniques for converting data into a format suitable for output on a computer display, for example a GUI (graphical user interface), and for displaying graphics, are well known, and are not discussed herein.

Referring to FIG. 1, the SAN 100 includes agent1 102, agent2 104, agent3 106, switch1 108, switch2 110, switch3 112, and switch4 114. Generally, the SAN 100 may be implemented using Fibre Channel network(s) and/or Ethernet network(s). FIG. 2 shows additional details of the SAN 100, namely disk1 202 coupled to agent1 102, disk2 204 coupled to agent2 104, and disk3 206 coupled to agent3 106. The computing network 200 shown in FIG. 2 includes the SAN 100, and also includes client 208, which is coupled to switch4 114 via connector 210. The client 208 may also include a hardware bus adapter (HBA) (not shown), for coupling the client 208 to the connector 210. As an example, connector 210 may support FICON (FIber CONnector) or ESCON (Enterprise Systems CONnnector) communications channels. In addition to ESCON or FICON, connector 210 may support other types of networks, for example, Ethernet, and could utilize the Internet and/or wireless technology. Additional devices, for example hosts, clients, and/or servers (for example metadata servers), could also be coupled to the SAN 100.

The SAN 100 may include additional agents and switches, or less agents and switches, than as shown in FIG. 1. Also, SAN 100 may include other suitable storage devices, in addition to, or instead of, disk1 202, disk2 204, and disk3 206. For example, suitable storage devices could include hard disk drives, optical disks or discs (for example, CD-RW, DVD-RW, or DVD+RW), floppy disks, magnetic data storage disks or diskettes, magnetic tape, digital optical tape, a tape library, EPROMs, EEPROMs, RAM, Non-Volatile RAM, and flash memory. Additionally, CD-R, WORM, DVD-R, and/or DVD+R devices could be utilized. Storage devices may be incorporated into storage subsystems, which may be included in the SAN 100. Each storage device or storage subsystem may have a storage controller (not shown), and may be coupled to the network via a network adaptor (not shown). As an example, disk storage could be implemented with an IBM FAStT 900, and a tape library could be implemented with an IBM 3494 tape library using IBM 3590 drives, all of which are available from IBM Corporation. As another example, storage systems could be implemented with a Model F20 or Model 800 Enterprise Storage Server, available from IBM Corporation. As an example, switch1, 108, switch2 110, switch3 112, and/or switch4 114, may be implemented with a Cisco MDS 9216 Multilayer Fabric Switch, available from Cisco Systems, Inc.

An exemplary computing apparatus 300 is shown in FIG. 3. As an example, client 208, agent1 102, agent2 104, and/or agent3 106 could be implemented with an embodiment of the computing apparatus 300. The computing apparatus 300 includes a processor 302 (which may be called a processing device), and in some examples could have more than one processor 302. As an example, the processor may be a PowerPC RISC processor, available from International Business Machines Corporation, or a processor manufactured by Intel Corporation. The processor 302 may run any suitable operating system, for example, Windows 2000, AIX, Solaris™, Linux, UNIX, or HP-UX™. The computing apparatus 300 may be implemented on any suitable computer, for example a personal computer (having for example, an Intel processor running the Windows or Linux operating system), a computer workstation, a mainframe computer, a supercomputer (for example an IBM SP2 running the AIX operating system), or any other suitable computing device running any suitable operating system. In other examples, computing apparatus 300 could be an IBM xSeries server, or an IBM zSeries Parallel Sysplex server, such as a zSeries 900, running the z Operating System (Z/OS), or an IBM S/390 server running OS/390. Computing apparatus 300 could also run Tivoli Storage Manager (TSM), which is available from IBM Corporation. The computing apparatus 300 also includes a storage 304, a network interface 306, and an input/output 308, which are all coupled to the processor 302. The storage 304 may include a primary memory 310, which for example, may be RAM, and a non volatile memory 312. The non-volatile memory 312 could be, for example, a hard disk drive, a drive for reading and writing from optical or magneto-optical media, a tape drive, non-volatile RAM (NVRAM), or any other suitable type of storage. The storage 304 may be used to store data and application programs and/or other programming instructions executed by the processor. The network interface 306 may provide access to any suitable wired or wireless network or communications link.

### II. Operation

In addition to the various hardware embodiments described above, a different aspect of the invention concerns a method for presenting relationships.

A. Signal-Bearing Media

In the context of FIGS. 1, 2 and 3, the method aspects of the invention may be implemented, for example, by having client 208, agent1 102, agent2 104, and/or agent3 106, (which may be implemented with computing apparatus 300), execute a sequence of machine-readable instructions, which can also be referred to as code, for carrying out one or more examples of the invention or portions of the invention. Alternatively, method aspects of the invention may be implemented by having any other suitable computing device execute a sequence of machine-readable instructions, for carrying out one or more examples of the invention or portions of the invention. These instructions may reside in various types of signal-bearing media. In this respect, some aspects of the present invention concern a programmed product, comprising a signal-bearing medium or signal-bearing media tangibly embodying a program of machine-readable instructions executable by a digital processing apparatus to perform operations for presenting relationships.

This signal-bearing medium may comprise, for example, primary memory 310 and/or non-volatile memory 312. Alternatively, the instructions may be embodied in a signal-bearing medium such as the optical data storage disc 400 shown in FIG. 4. The optical disc can be any type of signal bearing disc or disk, for example, a CD-ROM, CD-R, CD-RW, WORM, DVD-R, DVD+R, DVD-RW, or DVD+RW. Additionally, whether contained in the computing system 200, or elsewhere, the instructions may be stored on any of a variety of machine-readable data storage mediums or media, which may include, for example, a “hard disk drive”, a RAID array, a magnetic data storage diskette (such as a floppy disk), magnetic tape, digital optical tape, RAM, ROM, EPROM, EEPROM, flash memory, programmable logic, any other type of firmware, magneto-optical storage, paper punch cards, or any other suitable signal-bearing media including transmission media such as digital and/or analog communications links, which may be electrical, optical, and/or wireless. For example, in some embodiments the instructions or code may be accessible from a file server over a network, or from other transmission media, and the signal bearing media embodying the instructions or code may comprise a transmission media, such as a network transmission line, wireless transmission media, signals propagating through space, radio waves, and/or infrared signals. Alternatively, the signal bearing media may be implemented in hardware logic, for example, an integrated circuit chip, a Programmable Gate Array (PGA), or an Application Specific Integrated Circuit (ASIC). As an example, the machine-readable instructions may comprise microcode, or may comprise software object code, compiled from a language such as “C++”. In another example, the machine-readable instructions may be included in a web page, or may be accessed via a web page.

B. Overall Sequence of Operation

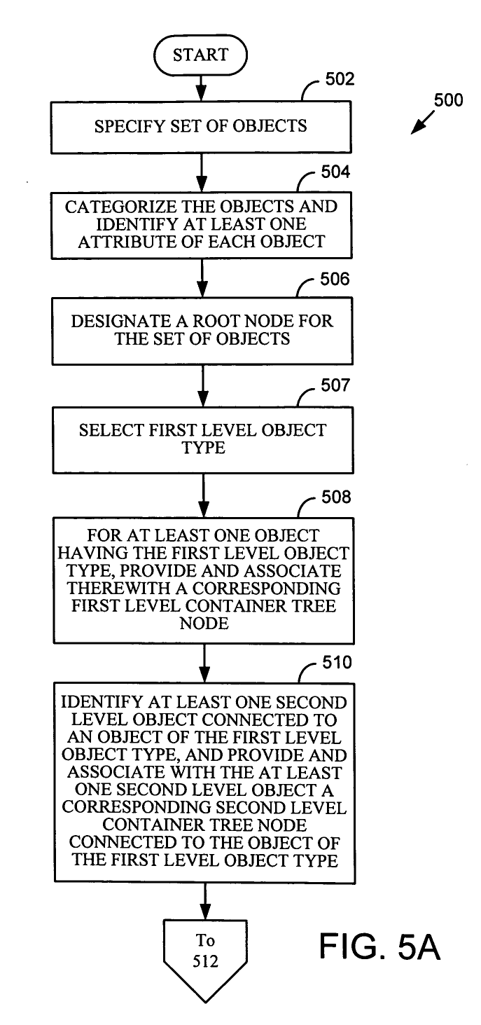

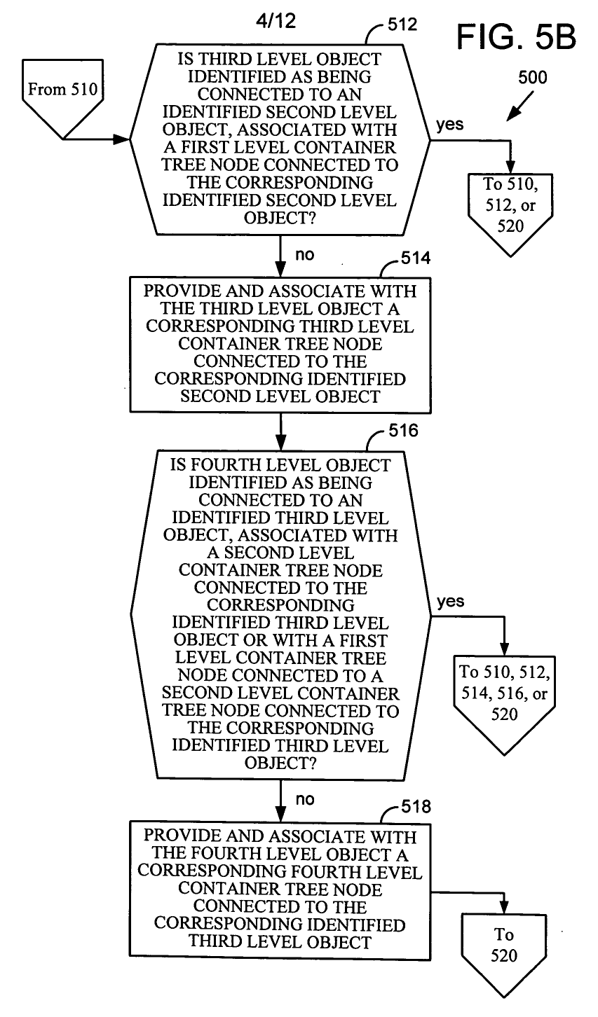

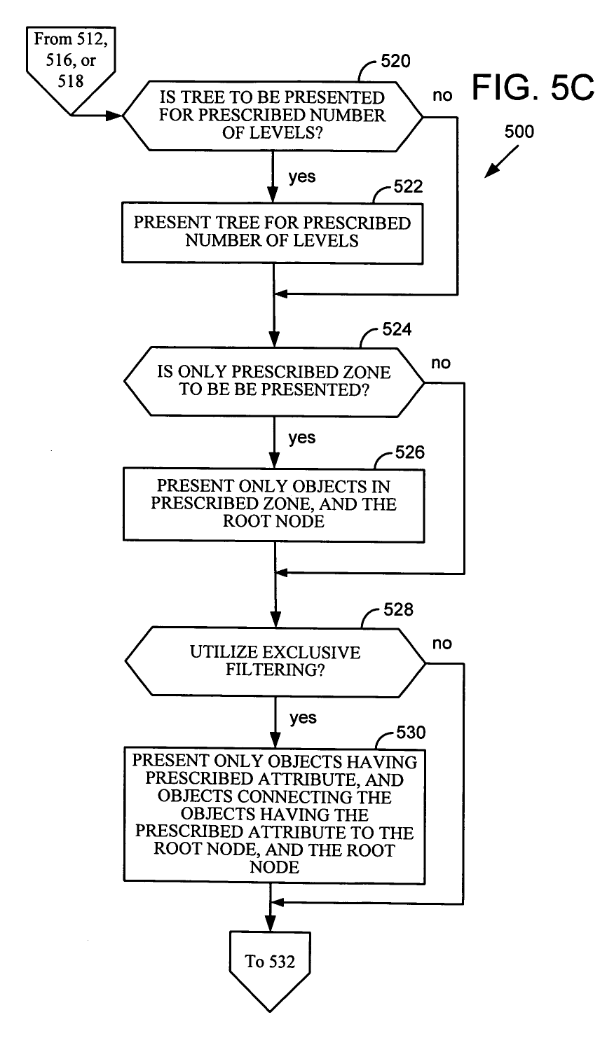

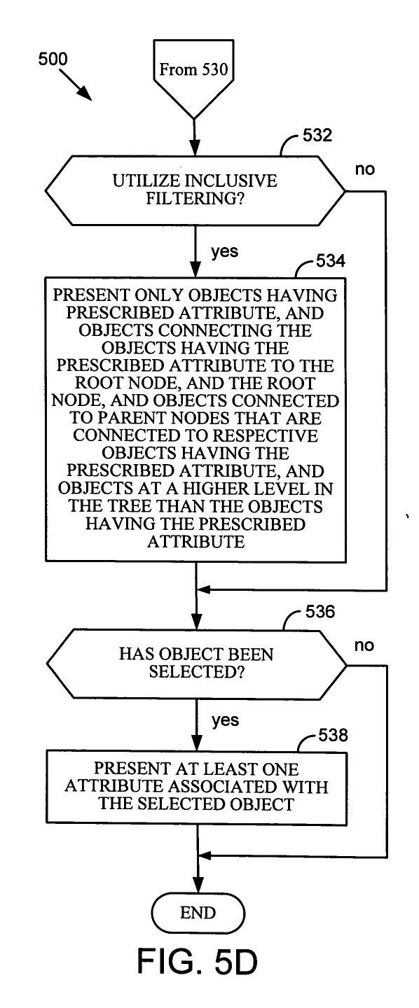

For ease of explanation, but without any intended limitation, exemplary method aspects of the invention are described with reference to the computing system 200 described above and shown in FIG. 2. An example of the method aspect of the present invention is illustrated in FIGS. 5A-D, which show a sequence 500 for a method for presenting relationships. Operations of the sequence 500 may be performed, for example, by any suitable computing device, as discussed above.

In some examples, the sequence 500 for presenting relationships may be employed with hierarchal relationships, and the relationships may be presented in a tree.

Referring to FIG. 5A, sequence 500 may include, and may begin with, operation 502, which comprises specifying a set of objects. As an example, the objects in the set of objects may be elements of a SAN. As another example, the objects in the set of objects may be elements of a computing network. However, the set of objects may comprise other types of objects representing other types of relationships, discussed above.

Sequence 500 may also include operation 504, which comprises categorizing the objects in the set of objects by object type and identifying at least one attribute of each object. In order to obtain information regarding the objects, as an example, information describing the objects and their attributes could be read from an XML file or could be read directly from a relational database.

Sequence 500 may also include operation 506, which comprises designating a root node of the set of objects. A “root node” may also be called a “logical root”.

Sequence 500 may also include operation 507, which comprises selecting a first level object type, for a first level.

Sequence 500 may also include operation 508, which comprises, for at least one object having the first level object type, providing and associating therewith a corresponding first level container tree node connected to the root node. In some examples, operation 508 may be performed for each object in the set of objects that has the first level object type. Alternatively, operation 508 may comprise adding to the first level at least one object of the first level object type, wherein the at least one object of the first level object type is connected to the logical root.

Sequence 500 may also include operation 510, which comprises, for at least one object having the first level object type, identifying at least one second level object connected thereto, and providing and associating with the at least one second level object a corresponding second level container tree node connected to the corresponding at least one object having the first level object type. A “second level” object is an object that is connected to an object in the first level. Similarly, a “third level” object is an object that is connected to an object in the second level, and so on. In an alternative embodiment, operation 510 may comprise providing at least one second level container tree node having an object associated therewith, wherein each at least one second level container tree node is connected to at least one first level container tree node. Alternatively, operation 510 may comprise adding a further object to the second level, wherein the further object is in the set of objects and is not of the first level object type. Alternatively, operation 510 may comprise adding a child container tree node at a level below the first level, wherein the child container tree node is added only if an object associated with the child container tree node is not in a path between the child container tree node and the root node.

Referring to FIG. 5B, sequence 500 may also include operation 512, which comprises, for at least one of the identified second level objects associated with a corresponding second level container tree node, identifying at least one third level object connected thereto, and determining if the identified third level object is associated with a first level container tree node connected to the corresponding identified second level object. If the identified third level object is not associated with a first level container tree node connected to the corresponding identified second level object, sequence 500 may also include operation 514, which comprises providing and associating with the at least one third level object a corresponding third level container tree node connected to the corresponding identified second level object. Alternatively, operations 512 and 514 may comprise adding an additional object from the set of objects to a location at a level below a second level, wherein the additional object is added to the location at the level below the second level only if the additional object is not also in a path between the location and the logical root. At least one object in the set of objects may be associated with more than one container tree node.

Sequence 500 may also include operation 516, which comprises, for at least one of the identified third level objects associated with a corresponding third level container tree node, identifying at least one fourth level object connected thereto, and determining if the identified fourth level object is associated with a second level container tree node connected to the corresponding identified third level object or with a first level container tree node connected to a second level container tree node connected to the corresponding identified third level object. If the identified fourth level object is not associated with a second level container tree node connected to the corresponding identified third level object and is not associated with a first level container tree node connected to a second level container tree node connected to the corresponding identified third level object, sequence 500 may also include operation 518, which comprises providing and associating with the at least one fourth level object a corresponding fourth level container tree node connected to the corresponding identified third level object. Alternatively, operations 516 and 518 may comprise for at least one of the identified third level objects associated with a corresponding third level container tree node, identifying at least one fourth level object connected thereto, and providing and associating with the at least one fourth level object a corresponding fourth level container tree node connected to the corresponding identified third level object if the identified fourth level object is not also at a higher level in a path between the identified fourth level object and the root node.

Sequence 500 may also include determining if there is another level of objects to add to the tree, at one or more locations in the sequence 500, for example, before one or more of operations 510, 512, 516, and/or after operation 518. Referring to FIG. 5C, sequence 500 may also include operation 520, which comprises determining if the tree is to be presented for only a prescribed number of levels. If the tree is to be presented for a prescribed number of levels, then sequence 500 may also include operation 522, which comprises presenting the tree for the prescribed number of levels.

Sequence 500 may also include operation 524, which comprises determining if only a prescribed zone defined by a subset of objects in the set of objects is to be presented in the tree. If only a prescribed zone is to be presented in the tree, then sequence 500 may also include operation 526, which comprises presenting only objects in a prescribed zone defined by a subset of objects in the set of objects, and the root node.

Sequence 500 may also include operation 528, which comprises determining if exclusive filtering is to be utilized. If exclusive filtering is to be utilized, then sequence 500 may also include operation 530, which comprises presenting in the tree only objects having a prescribed attribute, and objects connecting the objects having the prescribed attribute to the root node, and the root node.

Referring to FIG. 5D, sequence 500 may also include operation 532, which comprises determining if inclusive filtering is to be utilized. If inclusive filtering is to be utilized, then sequence 500 may also include operation 534, which comprises presenting in the tree only objects having a prescribed attribute, and objects connecting the objects having the prescribed attribute to the root node, and the root node, and objects connected to parent nodes that are connected to respective objects having the prescribed attribute, and objects at a higher level in the tree than the objects having the prescribed attribute.

As an example, the prescribed attribute for exclusive or inclusive filtering may be a state. For example, a state may be an error state, a warning state, or an up state. As another example, the prescribed attribute may be the attribute of being connected to a specific object. As another example, the prescribed attribute may be manufacturer identification associated with a specified manufacturer. As another example, the prescribed attribute may be a specified operating system type. As another example, the prescribed attribute may be a specified port.

Sequence 500 may also include operation 536, which comprises determining if an object has been selected (for example by a user right clicking on a mouse). If the object has been selected, sequence 500 may also include operation 538, which comprises presenting at least one attribute associated with the object. As an example, the at least one attribute associated with an object may be presented in a separate window.

C. Additional Discussion

Some examples of the invention may be called a method and system for presenting complex relationships in a simple hierarchy. Examples of the invention provide a method of presenting complex relationships as a simple hierarchical relationship (for example, a tree). This makes it possible to simultaneously see both an abstraction of the “big picture”, and the low-level details of how individual objects connect into that picture, without over-simplifying the displayed relationships, and without requiring a complicated graphics engine. Some examples of the invention may include GUI (Graphical User Interface) behaviors.

In order to present complex many-to-many relationships in a flat tree, examples of the invention permit child nodes to belong to more than one parent. This is accomplished by adding a layer of abstraction, wherein tree nodes are all unique objects, but each tree node encapsulates another object, and the encapsulated object can appear in the tree multiple times.

Examples of the invention overcome the problem of infinite recursion, which may occur because many-to-many relationships can create infinite loops when displayed. This problem must be overcome in order to be able to apply filters. Some prior art has avoided this problem by populating only one level of a tree at a time. However, when only one level is populated at a time, it is very difficult to see how all of the objects are interconnected. Instead of using this “dynamic population” model, some examples of the invention prevent the possibility of infinite recursion by utilizing an algorithm wherein, before a child node is added to a parent, it is determined whether the object encapsulated by the child node has already been added to the tree somewhere between the parent and the root. If the object already exists in this path, then the child node will not be added.

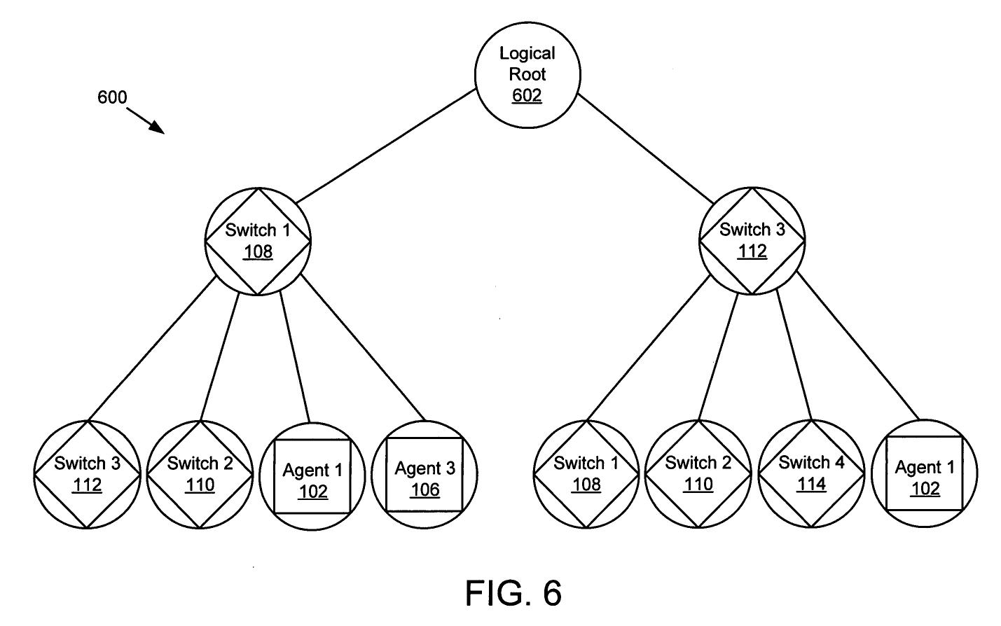

In order to present the relationships between the objects of the SAN 100 in accordance with some examples of the invention, the objects are categorized, and one category is chosen to be the top level of the hierarchy. As an example, the SAN 100 may be categorized into two groups: switches and agents. As an example, switches may be chosen as the top level category. Also, a root for the tree is designated. The root node, also called a logical root, is a logical name for the group of objects being displayed. For example, the root node may be called “My SAN” (or may just be called the logical root). All of the top-level category objects (the switches) may be added as children of the root. However, the objects are not added directly to the root. Rather, container tree nodes are added, which reference respective associated objects. This extra layer of abstraction (container tree nodes), permits adding the same object into the tree multiple times because each tree node that is added to the tree has a unique existence in the tree (even though the object it references may not). After all of the switches have been associated with container tree nodes, and those container tree nodes have been added to the root, a second pass is conducted in which child nodes are added to each switch for every object connected to each respective switch (including other switches). For example, switch1 108 has as children, switch2 110, switch3 112, agent1 102, and agent3 106. Switch2 110 and switch3 112 also have switch1 108 as one of their children, but because of the unique tree node container method described above, this is not a problem. FIG. 6 shows a partial view of the relationships of the SAN 100 of FIG. 1 represented as a tree 600 constructed according to this procedure.

Because FIG. 6 represents only a portion of the total tree required to display the relationships in the SAN 100, it may appear that this method of viewing the SAN is more complicated than the simple display technique present in FIG. 1. However, as the number of objects and the number of connections between objects increases, so does the difficulty of providing a rendering like FIG. 1. Specifically, as more and more objects fill the screen, determining where to render the next object and how to show the connections between the next object and an object that is physically distant from the next object in the display, become serious issues. However, these issues are not a problem for the methodology described for examples of the invention. Examples of the invention can easily scale to hundreds of objects, while, in contrast, a display like FIG. 1 quickly runs out of screen real estate and becomes unusable if more than approximately a dozen objects are displayed.

In FIG. 6, the circles represent the tree node containers that make up the tree. The diamonds and squares inside those containers represent the actual switch and agent objects. Note that the diamond representing switch1 108 as the child of the root 602 is exactly the same object as the diamond representing switch1 108 as the child of switch3 112. Since these are the same object, changes to one of them will immediately affect the other. Although for simplicity this example shows only two levels of a hierarchy, in a more complex SAN, there would likely be more levels, because storage subsystem devices, disks, and LUNs, etc., may also need to be displayed. This method can easily handle these additional levels by continuing to add child tree nodes as necessary, provided that, when a child node is being added to the tree, the child can only be added if the object the child node is representing is not already represented on the tree path between the current node and the root. If this rule is obeyed, any number of additional levels can be added to the hierarchy. The tree may also be constructed without obeying this rule, but that “infinite drill-down” approach results in an inferior presentation because it does not help to simplify the presentation of the relationships.

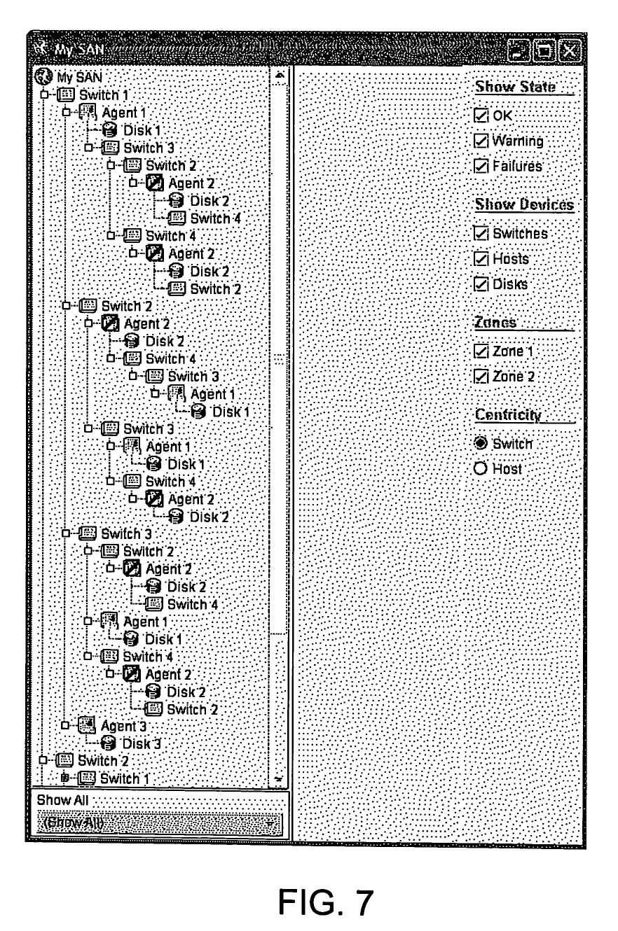

FIG. 7 is a representation of a window displaying a tree showing the fully expanded contents of switch1 108, utilizing an infinite-recursion preventing algorithm in accordance with an example of the invention. In FIG. 7, there are a lot of objects in the tree under switch1 108. This is the case because using this algorithm results in every relationship in the SAN 100 being displayed under each child of the root. Because this is redundant information, the algorithm can be refined further if it is known how many levels are being represented in the tree. For example, if the objects being tracked include Switches, Agent/Computers, and Disks (displayed as a hierarchy), then there is no need to add any levels to the tree beyond three levels, because any relationships lower than three levels will be displayed somewhere else in the tree. If a user needs immediate access to those additional relationships, (beyond the 3rd level), there are several ways to see them. The user can filter for all instances of the object they are currently looking at, they can search for the next instance, they can click on the object to see its properties, or they can set the object as the root.

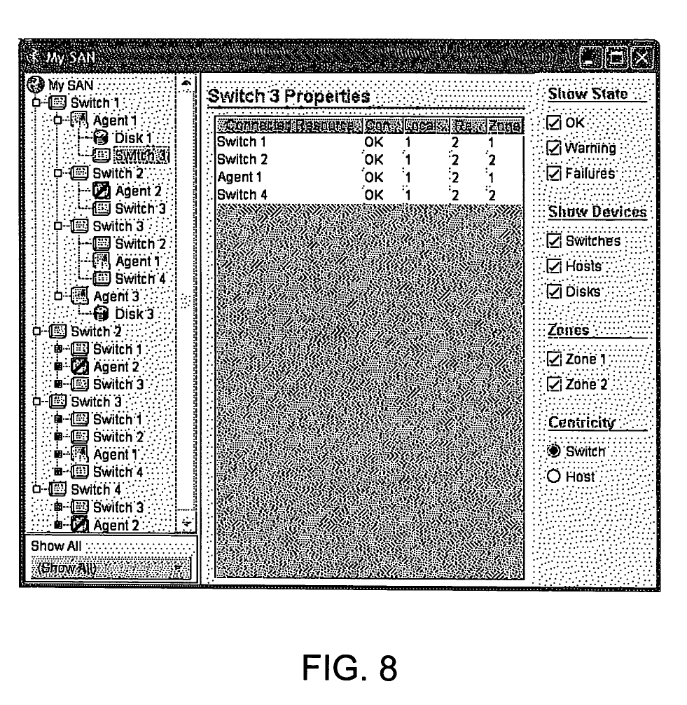

FIG. 8 shows the fully expanded contents of switch1 108 using a helper algorithm that limits the number of levels to 3. In the tree shown in FIG. 8, switch3 112 can no longer be drilled into as it could in the tree shown in FIG. 7, but no information has been lost, because the connections of switch3 112 can be seen in several other places in the tree. Also, the connections of switch3 112 may also be seen by clicking on switch3 in the tree to reveal its “properties” which may include the resources it is connected to (along with information about those connections).

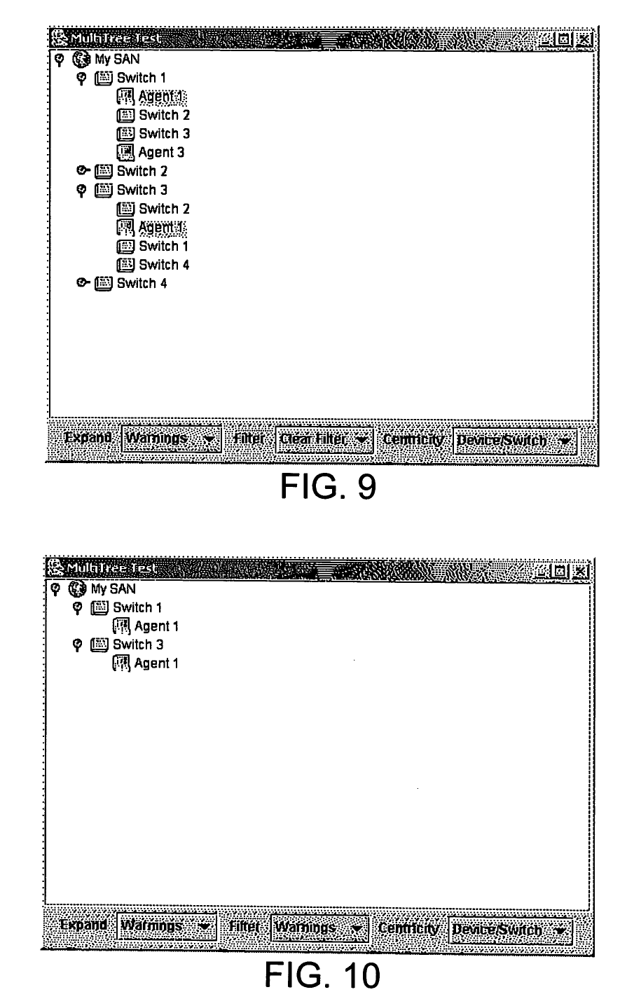

A methodology for mapping complex relationships into a tree has been discussed above. Using that mapping to provide different kinds of views so that, using the same mapping, a user can see both the fill “big picture” view and specific kinds of relationships will now be discussed. Two different kinds of filtering, inclusive filtering and exclusive filtering, may be applied to a tree to clarify specific relationships. With inclusive filtering, a user specifies the relationships or objects of interest, and the tree expands to show only those relationships or objects. FIG. 9 shows what the tree may look like if a user employs inclusive filtering to display a physical object (for example, all instances of agentl 102) or a logical state view (for example, all instances of objects in a “warning” state). FIG. 10 shows the same filter from FIG. 9 applied using exclusive filtering. Exclusive filtering shows only the objects of interest and the path from those objects to the root, and the root. By utilizing this kind of filtering, it is easy for a user to cut through the noise of managing hundreds of resources, and permits focusing only on the resources that are of interest, such as devices in a failed state, devices belonging to a particular zone (discussed below), or devices connected to switch1 108. Examples of the invention may also provide for showing state being propagated up to the root.

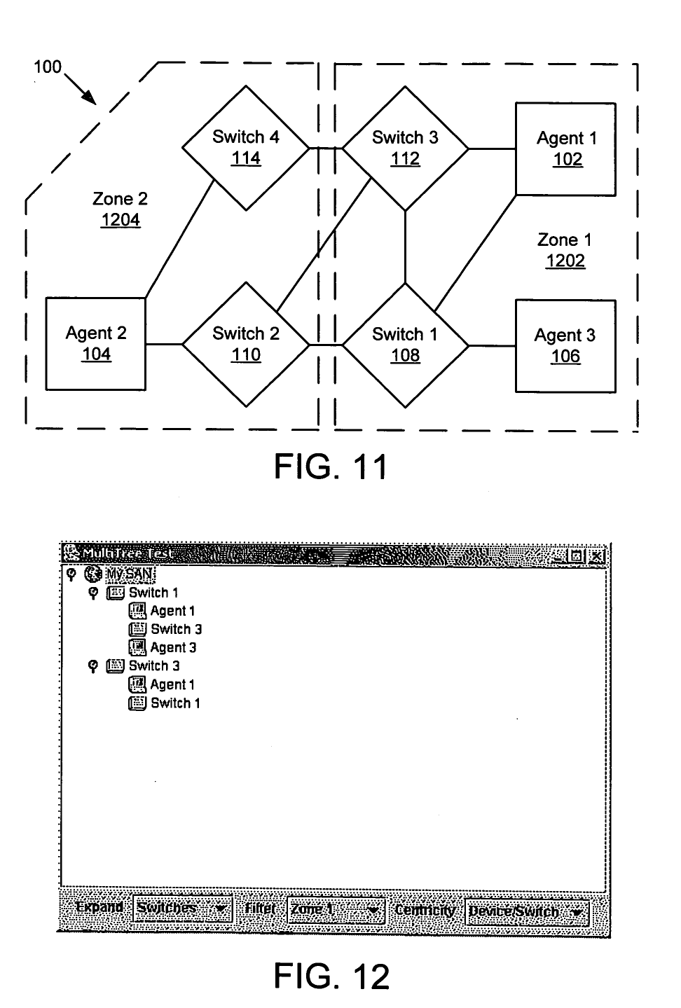

The exclusive filtering concept described above may be used to view different zones within a SAN. As an example, zones could be specified based on customer identification, or other attribute(s). FIG. 11 shows the sample SAN 100 divided into two zones, zone1 1202, and zone 2 1204. Switch1 108, switch3 112, agent1 102, and agent3 106 have been assigned to zone1 1202, and switch4 114, switch2 110, and agent2 104 have been assigned to zone2 1204.

If an exclusive filter is used to show only resources of zone1 1202, the tree will appear as depicted in FIG. 12. Another filter could be utilized to display only zone2 1204, or the filter could be cleared to present a full view of the SAN 100.

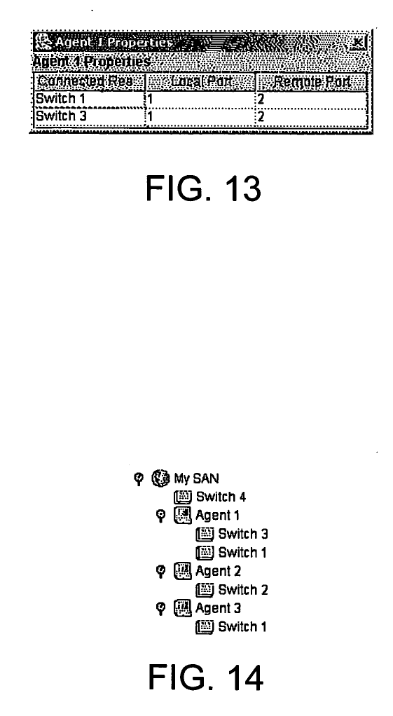

A filter may be applied to any attribute of an object in a tree. In the case of a SAN, attributes may include, for example, manufacturer, operating system (OS) type, state (error/failed/up/etc.), or even port numbers. Rather than trying to display all of these attributes in a tree, however, the attributes may be presented in a separate window (perhaps in a pop-up dialog accessed by right-clicking on an object in the tree). FIG. 13 shows a simple example of what such an “attributes view” might look like for agent 1 102. An attributes view could be used to identify attributes for use in a filter. For example, if agent1 102 has an attribute of being a Linux box, then a user might want to search for other Linux boxes in the network. An attributes view could also be used to gather more information about a problematic device. For example, if a user can no longer see resources for agent1 102, then the user may want to determine what port agent1 102 is connected to on switch1 108.

To create a tree in accordance with examples of the invention, one category of objects is selected to be the “top level” category. However, the selection of the top level category is arbitrary and can be changed dynamically. For example, it is possible to present a host-computer-centric view (or even a LUN-centric-view) rather than a switch-centric view. This ability to dynamically modify the display model makes this methodology adaptable so that it can change to match the user's needs. FIG. 14 shows the SAN 100 presented from a host-computer-centric view.

### III. Other Embodiments

The preceding disclosure describes a number of illustrative embodiments of the invention. It will be apparent to persons skilled in the art that various changes and modifications can be made to the described embodiments without departing from the scope of the invention as defined by the following claims. Also, although elements of the invention may be described or claimed herein in the singular, the plural is contemplated unless limitation to the singular is explicitly stated.

What is claimed is:

1. A signal bearing medium tangibly embodying a program of machine-readable instructions executable by a digital processing apparatus to perform operations for presenting relationships, the operations comprising:
specifying a set of objects;
designating a logical root for the set of objects;
selecting a first level object type for a first level;
adding to the first level at least one object of the first level object type, wherein the at least one object of the first level object type is connected to the logical root; and
adding an additional object from the set of objects to a location at a level below a second level, wherein the additional object is added to the location at the level below the second level only if the additional object is not also in a path between the location and the logical root.

2. The signal bearing medium of claim 1, wherein the operations further comprise adding a further object to the second level, wherein the further object is in the set of objects and is not of the first level object type.

3. A signal bearing medium tangibly embodying a program of machine-readable instructions executable by a digital processing apparatus to perform operations for presenting relationships, the operations comprising:
specifying a set of objects;
designating a root node of the set of objects;
selecting a first level object type for a first level;
for at least one object having the first level object type, providing and associating therewith a corresponding first level container tree node connected to the root node; and
adding a child container tree node at a level below the first level, wherein the child container tree node is added only if an object associated with the child container tree node is not in a path between the child container tree node and the root node.

4. The signal bearing medium of claim 3, wherein the operations further comprise providing at least one second level container tree node having an object associated therewith, wherein each at least one second level container tree node is connected to at least one first level container tree node.

5. A signal bearing medium tangibly embodying a program of machine-readable instructions executable by a digital processing apparatus to perform operations for presenting relationships, the operations comprising:
specifying a set of objects;
designating a root node of the set of objects;
selecting a first level object type;
for at least one object having the first level object type, providing and associating therewith a corresponding first level container tree node connected to the root node;
for at least one object having the first level object type, identifying at least one second level object connected thereto, and providing and associating with the at least one second level object a corresponding second level container tree node connected to the corresponding at least one object having the first level object type; and
for at least one of the identified second level objects, identifying at least one third level object connected thereto, and providing and associating with the at least one third level object a corresponding third level container tree node connected to the corresponding identified second level object if the third level object is not associated with a first level container tree node connected to the corresponding identified second level object.

6. The signal bearing medium of claim 5, wherein the relationships are hierarchal relationships, and wherein the relationships are presented in a tree.

7. The signal bearing medium of claim 6, wherein the tree is presented for a prescribed number of levels.

8. The signal bearing medium of claim 6, wherein only objects in a prescribed zone defined by a subset of objects in the set of objects, and the root node, are presented in the tree.

9. The signal bearing medium of claim 5, wherein the operations further comprise categorizing the objects in the set of objects by object type and identifying at least one attribute of each object.

10. The signal bearing medium of claim 6, wherein only objects having a prescribed attribute, and objects connecting the objects having the prescribed attribute to the root node, and the root node, are presented in the tree.

11. The signal bearing medium of claim 6, wherein only objects having a prescribed attribute, and objects connecting the objects having the prescribed attribute to the root node, and the root node, and objects connected to parent nodes that are connected to respective objects having the prescribed attribute, and objects at a higher level in the tree than the objects having the prescribed attribute, are presented in the tree.

12. The signal bearing medium of claim 10, wherein the prescribed attribute is a state.

13. The signal bearing medium of claim 10, wherein the prescribed attribute is an error state.

14. The signal bearing medium of claim 10, wherein the prescribed attribute is an up state.

15. The signal bearing medium of claim 10, wherein the prescribed attribute is the attribute of being connected to a specific object.

16. The signal bearing medium of claim 10, wherein the prescribed attribute is manufacturer identification associated with a specified manufacturer.

17. The signal bearing medium of claim 10, wherein the prescribed attribute is a specified operating system type.

18. The signal bearing medium of claim 5, wherein the operations further comprise presenting at least one attribute associated with an object.

19. The signal bearing medium of claim 5, wherein the operations further comprise presenting at least one attribute associated with an object in a separate window, responsive to the object being selected.

20. The signal bearing medium of claim 5, wherein at least one object in the set of objects is associated with more than one container tree node.

21. The signal bearing medium of claim 5, wherein the objects in the set of objects are elements of a SAN.

22. The signal bearing medium of claim 5, wherein the objects in the set of objects are elements of a computing network.

23. The signal bearing medium of claim 5, wherein the operations further comprise, for at least one of the identified third level objects associated with a corresponding third level container tree node, identifying at least one fourth level object connected thereto, and providing and associating with the at least one fourth level object a corresponding fourth level container tree node connected to the corresponding identified third level object if the identified fourth level object is not associated with a second level container tree node connected to the corresponding identified third level object and is not associated with a first level container tree node connected to a second level container tree node connected to the corresponding identified third level object.

24. The signal bearing medium of claim 5, wherein the operations further comprise, for at least one of the identified third level objects associated with a corresponding third level container tree node, identifying at least one fourth level object connected thereto, and providing and associating with the at least one fourth level object a corresponding fourth level container tree node connected to the corresponding identified third level object if the identified fourth level object is not also at a higher level in a path between the identified fourth level object and the root node.

25. The signal bearing medium of claim 5, wherein the operation of, for at least one object having the first level object type, providing and associating therewith a corresponding first level container tree node connected to the root node, is performed for each object in the set of objects that has the first level object type.

26. A computing system, comprising:
a memory; and
a processing device coupled to the memory, wherein the processing device is programmed to perform operations for presenting relationships, the operations comprising:
specifying a set of objects;
designating a root node of the set of objects;
selecting a first level object type for a first level;
for at least one object having the first level object type, providing and associating therewith a corresponding first level container tree node connected to the root node; and
adding a child container tree node at a level below the first level, wherein the child container tree node is added only if an object associated with the child container tree node is not in a path between the child container tree node and the root node.

27. A computing system, comprising:
means for specifying a set of objects;
means for designating a root node of the set of objects;
means for selecting a first level object type for a first level;
means for, for at least one object having the first level object type, providing and associating therewith a corresponding first level container tree node connected to the root node; and
means for adding a child container tree node at a level below the first level, wherein the child container tree node is added only if an object associated with the child container tree node is not in a path between the child container tree node and the root node.

28. A method for presenting relationships, comprising:
specifying a set of objects;
designating a root node of the set of objects;
selecting a first level object type for a first level;
for at least one object having the first level object type, providing and associating therewith a corresponding first level container tree node connected to the root node; and
adding a child container tree node at a level below the first level, wherein the child container tree node is added only if an object associated with the child container tree node is not in a path between the child container tree node and the root node.
